(19) United States
(12) Patent Application Publication
(10) Pub. No.: US 2026/0115809 A1
(43) Pub. Date: Apr. 30, 2026

(54) ROTARY CUTTING APPARATUSES AND CUTTING INSERTS FOR SAME

(71) Applicant: Kennametal Inc., Latrobe, PA (US)

(72) Inventors: Berthold Zeug, Fürth (DE); Bernhard Eckl, Fürth (DE); Michael Schuffenhauer, Fürth (DE); Ruy Frota de Souza Filho, Latrobe, PA (US); Austin Baer, Latrobe, PA (US)

(73) Assignee: Kennametal Inc., Latrobe, PA (US)

(21) Appl. No.: 18/928,565

(22) Filed: Oct. 28, 2024

(51) Int. Cl. B23B 27/16

(52) U.S. Cl. CPC B23B 27/1611

(57) ABSTRACT

A cutting apparatus can include a cutting insert having one or more discharge grooves that are generally conical in shape. Each discharge groove can be positioned adjacent a respective back shoulder edge of the cutting insert to help direct metal or other material away from the workpiece as a hole, bore, or other type of aperture is formed in the workpiece. Some embodiments of the cutting insert can include a projection or shank that can be positionable within a hole of a rotatable member for attachment of the cutting insert to the member.

### FIELD OF THE INVENTION

The present invention relates to rotary cutting tools (e.g. drills, etc.) and cutting inserts for cutting tools (e.g. undercutting drill bits, undercutting inserts, etc.).

### BACKGROUND OF THE INVENTION

Examples of cutting tool assemblies can be found in U.S. Pat. Nos. 11,839,920, 11,529,687, 11,090,736, 10,576,552, 9,937,567, 8,840,347, 8,807,888, 8,764,354, 8,092,126, 7,625,161, 7,467,915, and 7,407,350 as well as U.S. Patent Application Publication Nos. 2024/0198433, 2024/0024958 and 2022/0339710. Cutting tools can be used in metalworking, for example. Some cutting tools can be stationary. Other types of cutting tools can be moveable (e.g. rotatable, etc.). A cutting tool can be utilized to manipulate a workpiece to drill holes or other types of apertures for forming a device, a part, or a component part, for example.

### SUMMARY OF THE INVENTION

We determined that some cutting tools can experience significant stress during use. We found that this can be the case for undercutting of different objects, for example. High stress can result in a cutting tool or an insert of a cutting tool fracturing or breaking. This can result in the tool or insert needing to be repaired or replaced and can delay manufacturing activities.

Embodiments of a cutting tool and a cutting insert for a cutting tool (e.g. a rotary cutting tool, drill, etc.) can be configured to help avoid high stress conditions during metalworking. For example, embodiments of a cutting insert can be provided that define one or more discharge grooves that are generally conical in shape. Each discharge groove can be positioned adjacent a respective back shoulder edge of the cutting insert to help direct metal or other material away from the workpiece as a hole, bore, or other type of aperture is formed in the workpiece. Each generally conical groove can have a cutting end mouth that is in fluid communication with a distal discharge end mouth via a generally conical shaped channel that extends from the cutting end mouth to the discharge end mouth. Each mouth can be circular in shape (e.g. half circular, one third circular, etc.) in some embodiments. In other embodiments, each mouth can be generally oval or elliptical in shape such that a center of the cutting end mouth is offset relative to a center of the discharge end mouth. The channel that extends between the cutting end mouth and the discharge end mouth can be generally conical in shape (e.g. be a half conical shaped extending channel, be a half frustrum shaped extending channel, etc.).

In some embodiments, a portion of the cutting insert positioned between a back shoulder edge and a linearly extending gap that is in communication with the generally conical channel can be positioned to define a side of the channel such that a portion of the channel is within an overhang portion of a wall that extends from a back shoulder edge and overhangs the portion of the channel. The larger sized discharge end mouth can be sized and shaped to help reduce stress experienced by the cutting insert during cutting operations (e.g. rotation for undercutting, etc.). We have surprisingly found that a generally elliptical or oval shaped discharge end mouth that has its center offset relative to a center of the cutting end mouth can facilitate a stress reduction while also providing an effective pathway for material to pass away from a workpiece and tool during operation.

In a first aspect, a cutting apparatus can be provided. The cutting apparatus can include a cutting insert having a body. The body can have at least one cutting side. Each of the at least one cutting side can be configured to define a back shoulder edge and a first wall positioned between a groove and the back shoulder edge. The groove can be defined to be in communication with a first end mouth and a second end mouth opposite the first end mouth. The first end mouth can be smaller than the second end mouth. A gap can be defined in communication with the groove. The gap can be tapered such that a portion of the gap adjacent the second end mouth is larger than a portion of the gap defined adjacent to the first end mouth.

In some embodiments, the first end mouth can be curved and the second end mouth can be curved. Also, in some embodiments the groove can be generally conical in shape (e.g. be a half conical type shape, be a third of a cone type shape, be a half frustrum type shape, be a third of a frustrum type shape, etc.).

In some embodiments, the cutting insert may have a single cutting side. In other embodiments, the cutting insert can have two cutting sides or more than two cutting sides (e.g. three cutting sides, four cutting sides, etc.).

In a second aspect, the groove has a length that extends from the first end mouth to the second end mouth and the first end mouth can be offset relative to the second end mouth such that a first centerline passes linearly through a center of the first end mouth toward the second end mouth at an angle that is parallel to an axis of rotation about which the cutting insert is rotatable. The first centerline can pass linearly through a center of the first end mouth toward the second end mouth and be offset by an offset distance from a second centerline passing linearly through a center of the second end mouth toward the first end mouth at an angle that is parallel to the axis of rotation about which the cutting insert is rotatable. In some embodiments, the offset distance can be between 0.1 mm and 1 mm (e.g. 0.1 mm to 0.5 mm, 0.1 mm to 0.3 mm, etc.).

In a third aspect, the groove can be generally conical in shape. For example, the groove can be sized to be between half of a cone in shape to a quarter of a cone in shape. As another example, the groove can be sized to be a third of a cone in shape. As yet another example, the groove can be between half of a frustrum in shape to a quarter of a frustrum in shape (e.g. a third of a frustrum in shape, etc.).

In a fourth aspect, each of the at least one cutting side of the cutting insert can be configured to define a flute and a second wall positioned between the flute and the groove. Ine some embodiments, the second wall can include a chamfer between the flue and the second wall or between the groove and the second wall. In some embodiments, the groove can be positioned between the first wall and the second wall such wherein the groove has a first wall edge that extends linearly from a first end of the first end mouth to a first end of the second end mouth along a pre-selected angle. The first wall edge can be positioned between the first wall and the groove. The groove can also have a second wall edge that extends linearly from a second end of the first end mouth to a second end of the second end mouth along the pre-selected angle wherein the second wall edge is positioned between the second wall and the groove. In some embodiments, the pre-selected angle at which the first wall edge extends linearly can be between 0° and 60° and the pre-selected angle at which the second wall edge extends linearly can be between 0° and 60°.

In some embodiments, the first wall edge can be defined such that a portion of the first wall extends over a first portion of the groove closest to the first wall to enclose the first portion of the groove. The first portion of the groove can be in fluid communication with a central portion of the groove and the central portion of the groove can be in direct fluid communication with the gap.

In a fifth aspect, the groove can be defined to have a first wall edge adjacent the first wall such that a portion of the first wall extends over a first portion of the groove closest to the first wall to enclose the first portion of the groove. The first portion of the groove can be in fluid communication with a central portion of the groove. The central portion of the groove can be in direct fluid communication with the gap.

In a sixth aspect, the first wall extends linearly from the back shoulder edge to the gap or the first wall extends linearly from adjacent the back shoulder edge to adjacent the groove and also extends linearly from adjacent the back shoulder edge to adjacent the gap.

In a seventh aspect, the at least one cutting side is configured to define a flute and a second wall positioned between the flute and the groove wherein the second wall extends upwardly away from the groove and the flute is curved as the flute extends from the second wall to a transition side of the body of the cutting insert.

In an eighth aspect, the cutting apparatus can include a projection extending from an end of the body of the cutting insert. The projection can be sized and configured to be received within a hole of a moveable member. In some embodiments, the projection can be a shank or pin.

In a ninth aspect, the cutting apparatus can include the moveable member. The moveable member can have a first portion that is moveable relative to a second portion such that the moveable member is adjustable between an open position and a closed position. The moveable member can have the hole and the projection can be insertable into the hole. The moveable member can be rotatable.

In a tenth aspect, the at least one cutting side can be configured for undercutting of a workpiece.

In an eleventh aspect, the cutting apparatus of the first aspect can include one or more features of the second aspect, the third aspect, the fourth aspect, the fifth aspect, the sixth aspect, the seventh aspect, the eighth aspect, the ninth aspect, and/or the tenth aspect. Embodiments can also include other elements or features. Examples of such other features o elements can be appreciated from the exemplary embodiments discussed herein.

In a twelfth aspect, a cutting insert for a cutting apparatus is provided. The cutting insert can have a body that has a first cutting side, a second cutting side opposite the first cutting side, a first transitional side extending from a flute of the second cutting side to a back shoulder edge of the first cutting side, and a second transitional side extending from a flute of the first cutting side to a back shoulder edge of the second cutting side.

The first cutting side can be configured to define a first wall between the back shoulder edge of the first cutting side and a groove. The groove of the first cutting side can be defined to be in communication with a first end mouth and a second end mouth opposite the first end mouth. The first end mouth can be smaller than the second end mouth. A gap of the first cutting side can be defined in communication with the groove of the first cutting side. The gap of the first cutting side can be tapered such that a portion of the gap adjacent the second end mouth is larger than a portion of the gap defined adjacent to the first end mouth.

The second cutting side can be configured to define a first wall between the back shoulder edge of the second cutting side and a groove of the second cutting side. The groove of the second cutting side can be defined to be in communication with a first end mouth and a second end mouth opposite the first end mouth of the second cutting side. The first end mouth of the second cutting side can be smaller than the second end mouth of the second cutting side. A gap of the second cutting side can be defined in communication with the groove of the second cutting side. The gap of the second cutting side can be tapered such that a portion of the gap of the second cutting side adjacent the second end mouth of the second cutting side is larger than a portion of the gap of the second cutting side defined adjacent to the first end mouth of the second cutting side.

The first cutting side, the second cutting side, the first transitional side and the second transitional side can extend between a first end of the body and a second end of the body. In some embodiments, a projection can extend from the second end of the body.

In some embodiments, the first end mouth for each cutting side can be curved and the second end mouth for each cutting side can be curved. Also, in some embodiments the groove of each cutting side can be generally conical in shape (e.g. be a half conical type shape, be a third of a cone type shape, be a half frustrum type shape, be a third of a frustrum type shape, etc.).

In some embodiments, the cutting insert can also include other cutting sides (e.g. a third cutting side, a fourth cutting side, etc.).

In a thirteenth aspect, the first end mouth of the first cutting side is curved, the second end mouth of the first cutting side is curved, the first end mouth of the second cutting side is curved, and the second end mouth of the second cutting side is curved.

In a fourteenth aspect, the groove of the first cutting side has a length that extends from the first end mouth of the first cutting side to the second end mouth of the first cutting side. The first end mouth of the first cutting side can be offset relative to the second end mouth of the first cutting side such that a first centerline passing linearly through a center of the first end mouth of the first cutting side toward the second end mouth of the first cutting side at an angle that is parallel to an axis of rotation about which the cutting insert is rotatable is offset by an offset distance from a second centerline passing linearly through a center of the second end mouth of the first cutting side toward the first end mouth of the first cutting side at an angle that is parallel to the axis of rotation.

The groove of the second cutting side can have a length that extends from the first end mouth of the second cutting side to the second end mouth of the second cutting side. The first end mouth of the second cutting side can be offset relative to the second end mouth of the second cutting side such that a first centerline passing linearly through a center of the first end mouth of the second cutting side toward the second end mouth of the second cutting side at an angle that is parallel to the axis of rotation is offset by an offset distance of the second cutting side from a second centerline passing linearly through a center of the second end mouth of the second cutting side toward the first end mouth of the second cutting side at an angle that is parallel to the axis of rotation.

In some embodiments, the offset distance of the first cutting side can be between 0.1 mm and 1 mm and the offset distance of the second cutting side can be between 0.1 mm and 1 mm.

In a fifteenth aspect, the first cutting side can have a second wall between the groove of the first cutting side and the flute of the first cutting side and the second cutting side can have a second wall extending between the groove of the second cutting side and the flute of the second cutting side. The groove of the first cutting side can be positioned between the first wall of the first cutting side and the second wall of the first cutting side such that the groove of the first cutting side has a first wall edge that extends linearly from a first end of the first end mouth of the first cutting side to a first end of the second end mouth of the first cutting side along a preselected angle. The first wall edge of the first cutting side can be positioned between the first wall of the first cutting side and the groove of the first cutting side.

The groove of the first cutting side can also have a second wall edge that extends linearly from a second end of the first end mouth of the first cutting side to a second end of the second end mouth of the first cutting side along the pre-selected angle. The second wall edge of the first cutting side can be positioned between the second wall of the first cutting side and the groove of the first cutting side. In some embodiments, the pre-selected angle at which the first wall edge of the first cutting side extends linearly is between 0° and 60° and the pre-selected angle at which the second wall edge of the first cutting side extends linearly is between 0° and 60°.

The groove of the second cutting side can be positioned between the first wall of the second cutting side and the second wall of the second cutting side such that the groove of the second cutting side has a first wall edge that extends linearly from a first end of the first end mouth of the second cutting side to a first end of the second end mouth of the second cutting side along a pre-selected angle. The first wall edge of the second cutting side can be positioned between the first wall of the second cutting side and the groove of the second cutting side.

The groove of the second cutting side can also have a second wall edge that extends linearly from a second end of the first end mouth of the second cutting side to a second end of the second end mouth of the second cutting side along the pre-selected angle. The second wall edge of the second cutting side can be positioned between the second wall of the second cutting side and the groove of the second cutting side. In some embodiments, the pre-selected angle at which the first wall edge of the second cutting side extends linearly is between 0° and 60° and the pre-selected angle at which the second wall edge of the second cutting side extends linearly is between 0° and 60°.

In a sixteenth aspect, the cutting insert of the twelfth aspect can include one or more features of the thirteenth aspect, the fourteenth aspect, and/or the fifteenth aspect. Embodiments can also include other elements or features. Examples of such other features o elements can be appreciated from the exemplary embodiments discussed herein.

These and other embodiments shall be described in more detail herein and in the drawings that show exemplary embodiments. Therefore, other details, objects, and advantages will become apparent as the following description of certain present preferred embodiments thereof and certain present preferred methods of practicing the same proceeds.

### BRIEF DESCRIPTION OF THE DRAWINGS

Exemplary embodiments of a cutting apparatus, a cutting insert for a rotary cutting apparatus, and methods of making and using the same are shown in the accompanying drawings. It should be appreciated that like reference numbers used in the drawings may identify like components.:

FIG. 1 is an exploded view of a first exemplary embodiment of a cutting apparatus 1 illustrating an exemplary embodiment of a cutting insert 3 that can be positioned into a rotatable member 5 of the cutting apparatus.

FIG. 2 is a perspective view of the first exemplary embodiment of the cutting apparatus.

FIG. 3 is a side view of a first exemplary embodiment of a cutting insert that can be included in the first exemplary embodiment of the cutting apparatus 1.

FIG. 4 is schematic illustration of positioning of the cutting end mouth 4a and a discharge end mouth 4b for an exemplary embodiment of the cutting insert.

FIG. 5 is a cutting end perspective view of the first exemplary embodiment of the cutting insert that can be included in the first exemplary embodiment of the cutting apparatus 1.

FIG. 6 is a side view of a second exemplary embodiment of a cutting insert that can be included in the first exemplary embodiment of the cutting apparatus 1.

FIG. 7 is a cutting end perspective view of the second exemplary embodiment of the cutting insert that can be included in the first exemplary embodiment of the cutting apparatus 1.

FIG. 8 is an end view of the first exemplary embodiment of a cutting insert that can be included in the first exemplary embodiment of the cutting apparatus 1.

### DESCRIPTION

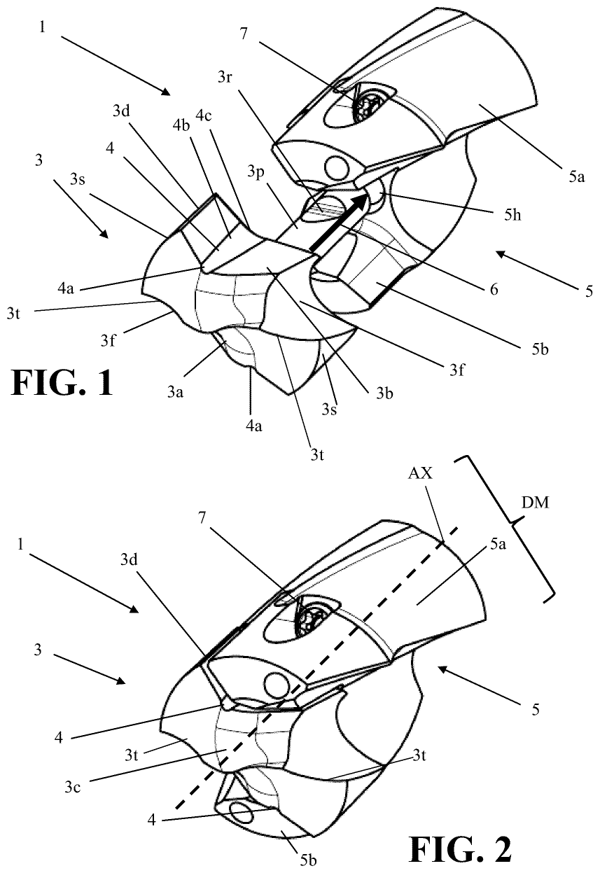

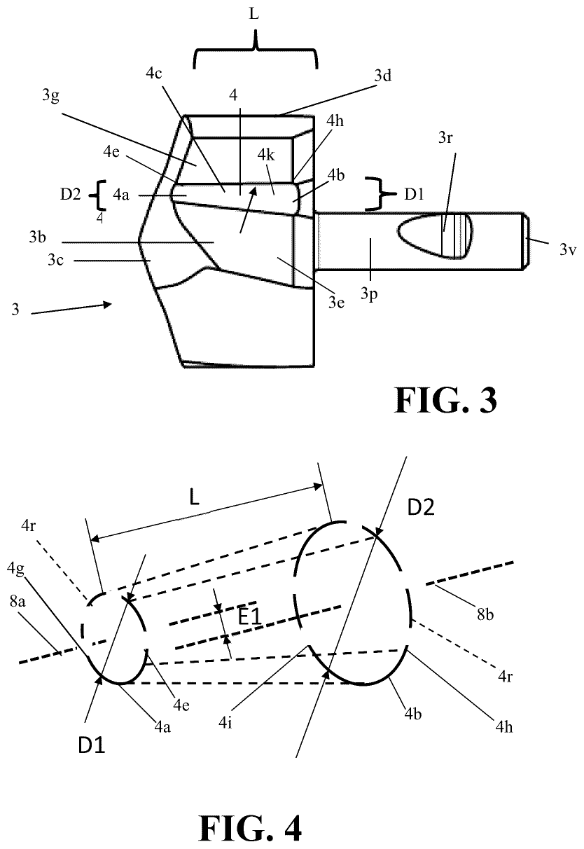

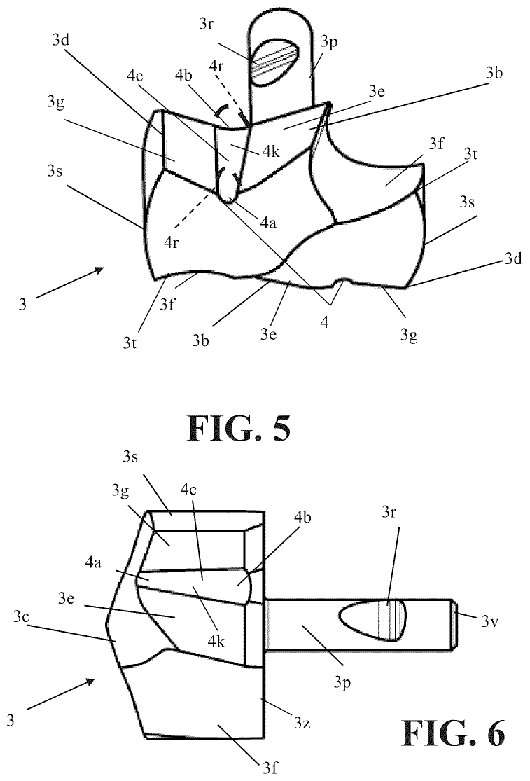

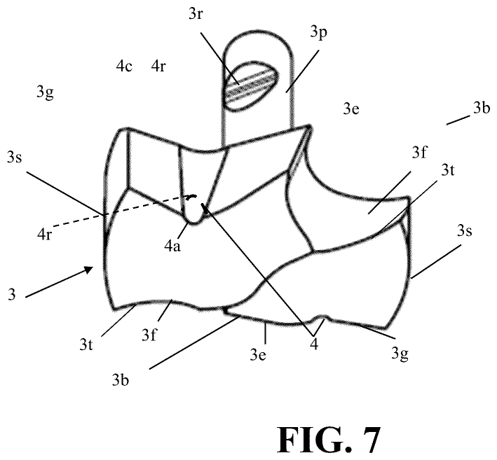

Referring to FIG. 1 through FIG. 8, a cutting tool 1 can include an elongated member 5 that retains a cutting insert 3 for movement of the cutting insert 3 to manipulate a workpiece via cutting of material from the workpiece. The cutting insert 3 can be a cutting head or cutting bit in some embodiments and the member 5 can be a rotatable member (e.g. rotatable shaft of a drill, rotatable bar, rotatable rod, etc.).

The member 5 can include a first portion 5a and a second portion 5b that are moveable between an open position in which a cutting insert can be removed from a hole 5h in the member 5 or inserted into the hole 5h of the member and a closed position in which the first and second portions are positioned to help retain the cutting insert 3.

A set screw 7 can be positioned to extend through the first portion 5a of the member 5 to engage a portion of the cutting insert 3 retained within the hole 5h of the body to help secure the cutting insert to the member 5 in some embodiments. For instance, the cutting insert 3 can include a projection 3p that extends from a cutting portion of the cutting insert 3 to be received within the hole 5h of the member 5 and can have a recess 3r defined in the projection 3p that is sized and shaped to contact a distal end of the set screw 7 for being retained in the member 5.

The cutting inert 3 can be positioned such that its shank or projection 3p is within the hole 5h while the member 5 while the member 5 is in its open position as indicated by arrow 6 in FIG. 1 and the member 5 is subsequently moved to its closed position. The distal end 3v of the projection 3p can be positioned within the hole 5h and the projection 3p can be slid into the hole 5h for positioning within the member 5 while the member 5 is in its open position, for example. After the cutting insert 3 is positioned so that the projection 3p is sufficiently within the hole 5h, the member 5 can be moved to its closed position so that the distal ends of the first and second portions 5a and 5b of the member 5 are in closer arrangement for retention of the cutting insert 3. The set screw 7 can then be adjusted to contact the projection 3p in recess 3r for securing the cutting insert 3.

Replacement of the cutting insert 3 can be performed as well. For instance, the set screw 7 can be moved to loosen its engagement with the projection 3p. The member 5 can also be adjusted from its closed position to its open position via motion of distal ends of the first and second portions 5a and 5b of the member 5 being moved away from each other. After the member 5 is in its open position and the set screw 7 is moved out of engagement with the projection 3p, the projection 3p can be removed from the hole 5h of the member 5 to remove the cutting insert 3 from the member 5. The cutting insert 3 that is removed may be replaced with a different cutting insert 3 if desired. Such a replacement can occur to adjust the cutting profile of the cutting apparatus by use of a different cutting insert or to replace a worn cutting insert 3 with a new cutting insert 3, for example.

The projection 3p of the cutting insert 3 can be an integral portion of the body 3c of the cutting insert 3. For example, the projection 3p can be a portion of the body 3c that is formed via a molding operation for forming the cutting insert 3p. Alternatively, the projection 3p can be a separate part from the cutting body 3c (e.g. the projection 3p can be a pin or shaft, etc.) that is secured within a channel defined in the body 3c via brazing or other type of suitable attachment mechanism.

The body 3c of the cutting insert 3 can be comprised of carbide material, steel, tool steel, a ceramic material, cemented carbide material or tungsten carbide material in some embodiments. Other embodiments may utilize other compositions for the cutting insert 3 that may be suitable for a particular application. In some embodiments, the cutting insert can include one or more cutting elements attached to a cutting edge 3t of the body 3c. Such a cutting element can be comprised of a harder material than the material of the body 3c (e.g. the cutting element can be comprised of polycrystalline Diamond (PCD), cubic boron nitride (CBN), a ceramic material, a carbide material, or other suitable material in some embodiments). In other embodiments, the one or more cutting edges 3t defined on the body 3c can be cutting edges defined in the body 3c via the forming of the body 3c (e.g. molding of body 3c, molding of body 3c and subsequent processing of cutting body 3c to form the body 3c, etc.).

The body 3c of the cutting insert 3 can have a first cutting side 3b and a second cutting side 3b opposite the first cutting side. A first transitional side 3s can extend between a back shoulder edge 3d of the first cutting side and a flute 3f of the second cutting side 3b. A second transitional side 3s can be opposite the first transitional side 3s can extend from a flute 3f of the first cutting side to a back shoulder edge 3d of the second cutting side 3b. The first cutting side 3b, second cutting side 3b, first transitional side 3s and second transitional side 3s can each extend between a first end 3a of the body 3c and a second end of the body opposite its first end. The projection 3p can be an elongated member (e.g. a shank, etc.) that extends from the second end 3z of the body 3c of the cutting insert 3 for insertion into the hole 5h of the moveable member 5 such that the second end 3z of the body 3c can be considered a tool facing end and the opposite first end of the body 3c can be considered an end of the body 3c that faces away from the moveable member 5 or away from the tool.

Each transitional side 3s of the cutting body can have a relatively smooth surface that may be curved or contoured to facilitate motion of the cutting insert 3. Each cutting side 3b can have a profile defined therein to help facilitate cutting of a workpiece via a back shoulder edge 3d of that cutting side 3b. The profile the first cutting side 3b can be a mirror image of the profile of the second cutting side 3b in some embodiments.

For instance, each cutting side 3b can be formed such that each cutting side 3b includes a back shoulder edge 3d, a generally conical shaped groove 4 positioned adjacent the back shoulder edge 3d, a first wall 3g extending from the back shoulder edge 3d to a back shoulder side of the groove 4, a flute 3f, and a second wall 3e extending from a flute facing side of the groove 4 to the flute 3f. In some embodiments, the first wall 3g can be considered a drive wall and the second wall 3e can be considered a centering wall.

As another example, each cutting side 3b can be formed such that each cutting side includes a shoulder edge 3d, a generally conical shaped groove 4, a first wall 3g positioned between the shoulder edge 3d and the groove 4, and a flute 3f. A second wall 3e can be positioned between the groove 4 and the flute 3f. In some embodiments, the first wall 3g and/or the second wall 3e can include a chamfer or be positioned adjacent to a chamfer.

In some embodiments, the flute 3f can extend from the second wall to an edge of the cutting side that is opposite the back shoulder edge 3d. The flute 3f can extend from the second wall 3e and terminate at an edge of the cutting side 3b that is opposite the back shoulder edge 3d adjacent a transitional side 3s, for example. Each cutting side 3b can also include a cutting edge 3t that can extend along a portion of an edge of the flute 3f. The flute 3f can be a contoured shaped portion of the cutting side that is curved or otherwise shaped to help facilitate motion of debris or chips away from the cutting edge 3t. For example, the flute 3f can be structured as a contoured portion of the cutting side 3b to help facilitate driving a flow of cut material away from the workpiece being cut as the cutting insert 3 is moved during a cutting operation.

In some embodiments, the first wall 3e can extend from the upper back shoulder edge 3d to a lower edge that defines a side of the groove 4. The first wall 3g can be sloped and have a smooth, linearly extending surface in some embodiments. In some embodiments, the first wall 3g can be considered a torque transmission wall.

The second wall 3e can extend upwardly from a second side of the groove 4 to the flute 3f in some embodiments. In some configurations, the second wall 3e can be considered a centering wall. The flute 3f can be a curved, recessed portion of the cutting side 3b that can extend downwardly along a curved surface from the second wall 3e to the transitional side 3s.

The conical groove 4 can also be sized and shaped to facilitate receipt of coolant fluid to help facilitate cooling of the cutting insert during cutting operations (e.g. by directing coolant to a cutting zone of the cutting insert, etc.). The coolant can be provided via a coolant delivery system or via one or more coolant injectors that may be positioned in the member 5.

The groove 4 can include a first end mouth 4a a second end mouth 4b opposite the second end mouth 4a, and an intermediate conical shaped portion 4c that extends from the fist end mouth 4a to the second end mouth 4b. The groove can be defined so that there is a gap 4k defined between the first wall 3g and the second wall 3e. This gap 4k can be generally frustrum in shape or conical in shape and the gap 4k can be in fluid communication with the groove 4 and extend from the first end mouth 4a to the second end mouth 4b. The groove 4 can be generally conical in shape and may be sized to be ⅓ of a conical shape or frustrum shaped groove or half of a conical shaped groove or frustrum shaped groove.

The gap 4k can be defined so that the gap 4k is sized and positioned to be empty space that would be the remaining portion of the conical shape or frustrum shape of the defined groove 4. For instance, the gap 4k between the first and second walls 3g and 3e can be defined to represent remainder of the generally conical shape of the space defined by the groove 4. In some embodiments, a side portion of the groove 4 that extends along the first wall 3g can be in an underhung position in which a portion of the first wall 3g can extend over this portion of the groove 4 closest to the first wall 3g to help enclose a portion of the first wall side portion of the groove 4 that is in fluid communication with a central portion that is exposed and in direct fluid communication with the gap 4k.

In some embodiments, each cutting side 3b can be sized and shaped to facilitate undercutting of a workpiece and the back shoulder edge(s) 3d can be defined to provide undercutting. Other embodiments can utilize other configurations to facilitate other types of cutting operations.

We have surprisingly found that the generally conical shaped groove 4 can be defined to provide improved cutting performance by reducing stress experienced by the body of the cutting insert 3 while moved (e.g. rotated) to cut material from a workpiece (e.g. perform undercutting on the workpiece). In particular, the generally conical type shape of the groove 4 has been found to contribute to a significant reduction in stress experienced by the body 3c near its second end (e.g. near the second end mouth 4b). Providing a groove 4 that has a smaller sized first end mouth 4a and a larger sized second end mouth 4b has been found to help reduce the stress experienced by the body while also permitting the groove to have a sufficient size and shape to facilitate cooling during the cutting operation.

The groove 4 can be sized to taper from the second end mouth 4b to the first end mouth 4a so that the second end mouth 4b is a largest width of the groove 4 and the first end mouth 4a is a smallest width of the groove 4. This type of tapering can be provided in conjunction with linearly extending side edges on the opposite sides of the groove 4. For instance, a first wall edge of the groove can extend linearly along a pre-selected length L at a pre-selected angle from a first end 4e of the first end mouth 4a to a first end 4h of the second end mouth 4b. A second wall edge of the groove can extend linearly along a per-selected length L at a pre-selected angle from a second end 4g of the first end mouth 4a to a second end 4i of the second end mouth 4b. The pre-selected angles at which these edges extend along the preselected length L can be between 0° and 60° in some embodiments (e.g. between 10° and 30° or between 7.5° and 45°, etc.). Gap 4k can be sized and defined between the first wall edge and second wall edge of the groove 4 such that the gap 4k tapers from a widest dimension adjacent the second end mouth 4b to a narrowest dimension adjacent the first end mouth 4a.

The first end mouth 4a and second end mouth 4b can also be curved. For instance, the fist end mouth 4a can be generally circular, oval, or elliptical in shape and the second end mouth 4b can be generally circular, oval, or elliptical in shape. For example, the first end mouth 4a can be sized and shaped as half a circle, a third of a circle, or a quarter of a circle, half an oval, a third of an oval, or a quarter of an oval, or half an ellipse, a third of an ellipse, or a quarter of an ellipse. The second end mouth 4b can be sized and shaped as half a circle, a third of a circle, a quarter of a circle, half an oval, a third of an oval, a quarter of an oval, half an ellipse, a third of an ellipse, or a quarter of an ellipse in a way in which the second end mouth 4b has a larger width or diameter than the first end mouth 4a.

The first end mouth 4a can have a generally circular, elliptical, or oval shape in which the curved first end mouth 4a extends laterally between the first wall 3g and second wall 3e along the first end 3a of the body 3c from its first end 4e to its second end 4g. A remaining portion of the circular, oval, or elliptical shape of the first end mouth 4a can be appreciated from broken line 4r.

The second end mouth 4b can have a generally circular, elliptical, or oval shape in which the curved second end mouth 4b extends laterally between the first wall 3g and second wall 3e along the second end of the body 3c from its first end 4h to its second end 4i. A remaining portion of the circular, oval, or elliptical shape of the second end mouth 4b can be appreciated from broken line 4r.

The first and second end mouths 4a and 4b can each have offset centers. The offsetting of these centers can provide a sizing of the gap 4k and groove 4 that can help provide a reduction in stress to the body 3c while also providing sufficient material in the first wall 3g to support the back shoulder edge 3d so the back shoulder edge 3d can withstand the cutting forces applied via motion (e.g. rotation) of the body 3c of the cutting insert 3 when it is used in a cutting operation.

As may best be appreciated from the schematic representation illustrated in FIG. 4, the first end mouth 4a can have a diameter D1 that is smaller than the diameter D2 of the second end mouth 4b. The first and second end mouths 4a and 4b can be aligned so that a first centerline 8a passing linearly through the center of the first end mouth 4a toward the second mouth 4b at an angle that is parallel to the angle at which the groove extends along its length L is offset by an offset distance E1 from a second centerline 8b passing linearly through the center of the second end mouth 4b toward the first end mouth 4a at an angle that is parallel to the angle at which the groove extends along its length L. The first and second end mouths 4a and 4b can also (or alternatively) be aligned so that a first centerline 8a passing linearly through the center of the first end mouth 4a toward the second mouth 4b at an angle that is parallel to the axis of rotation AX of the cutting insert 3 is offset by an offset distance E1 from a second centerline 8b passing linearly through the center of the second end mouth 4b toward the first end mouth 4a at an angle that is parallel to the axis of rotation AX. The first and second centerlines 8a and 8b can be parallel to each other and also parallel to the axis of rotation AX.

This offset distance E1 can be a pre-selected distance to facilitate improved coolant flow distribution while also providing a reduction in stress experienced adjacent the second end mouth 4b while the cutting insert 3 is moved or rotated for a cutting operation. For instance, the offset distance E1 can be between 0.1 mm and 1 mm, between 0.1 mm and 2.0 mm, or other suitable value. The value of the offset distance E1 can be selected to have a ratio with a diameter DM of the moveable member 5 (“DM”) to which the cutting insert 3 can be attached. In some embodiments, the offset distance E1 can be selected so that the ratio of the offset distance E1 to the diameter DM of the moveable member 5 (e.g. the ratio of E1/DM) can be between 0.04 to 0.10 (e.g. 0.065-0.90, 0.065-0.08, 0.05-0.80, etc.).

The diameter DM of the moveable member 5 can be the diameter of a rotatable drill to which the cutting insert 3 is connectable, for example. This diameter DM of the member 5 can be between 10 mm and 50 mm in some embodiments. In such exemplary embodiments, the value of the offset distance E1 can range from 0.48 mm to 5 mm, for example, so that the ratio of E1 to DM is between 0.04 and 0.10. In other such exemplary embodiments in which the diameter DM of the member 5 is between 10 mm and 50 mm, the value of the offset distance E1 can range from 0.65 mm to 4 mm, for example, so that the ratio of E1 to DM is between 0.065 and 0.08. Other embodiments can utilize other offset distances E1 and other diameters DM for the moveable member 5.

Each cutting side 3b of the body 3c can have the same structure (e.g. mirror image structures). For example, each cutting side 3b can have a back shoulder edge 3d, a first wall 3g, a groove 4 in communication with gap 4k, a second wall 3e, a cutting edge 3t, and a flute 3f that terminates at an edge of the cutting side opposite the back shoulder edge 3d that is adjacent with a transition side 3s that extends between the flute 3f and a back shoulder edge 3d of another cutting side 3b opposite that cutting side 3b. The sizing and dimensions of each cutting side 3b component can be the same. Similarly, each transition side 3s can have a similar shape and size or same shape and size.

For example, in some embodiments, the cutting insert 3 can include a body 3c having a first cutting side 3b, a second cutting side 3b opposite the first cutting side, a first transitional side 3s extending from a flute 3f of the second cutting side 3b to a back shoulder edge 3d of the first cutting side 3b, and a second transitional side 3s extending from a flute 3f of the first cutting side 3b to a back shoulder edge 3d of the second cutting side 3b. The first cutting side 3b can be configured to define a first wall 3g extending from the back shoulder edge 3d of the first cutting side 3b to a groove 4 or a first wall 3g that is positioned between the back shoulder edge 3d and the groove 4. The groove 4 of the first cutting side 3b can be defined to be in communication with a first end mouth 4a and a second end mouth 4b opposite the first end mouth 4a. The first end mouth 4a can be smaller than the second end mouth 4b and there can be a gap 4k of the first cutting side 3b defined in communication with the groove 4 of the first cutting side 3b. The gap 4k of the first cutting side 3b can be tapered such that a portion of the gap 4k adjacent the second end mouth 4b is larger than a portion of the gap 4k defined adjacent to the first end mouth 4a.

The second cutting side 3b can be configured to define a first wall 3g extending from the back shoulder edge 3d of the second cutting side 3b to a groove 4 of the second cutting side 3b or a first wall 3g that is between the back shoulder edge 3d of the second cutting side 3b and a groove 4 of the second cutting side 3b. The groove 4 of the second cutting side 3b can be defined to be in communication with a first end mouth 4a and a second end mouth 4b opposite the first end mouth 4a of the second cutting side 3b. The first end mouth 4a of the second cutting side 3b can be smaller than the second end mouth 4b of the second cutting side 3b. A gap 4k of the second cutting side 3b can be defined in communication with the groove 4 of the second cutting side 3b. The gap 4k of the second cutting side 3b can be tapered such that a portion of the gap 4k of the second cutting side 3b adjacent the second end mouth 4b of the second cutting side 3b is larger than a portion of the gap 4k of the second cutting side 3b defined adjacent to the first end mouth 4a of the second cutting side 3b.

The first cutting side 3b, the second cutting side 3b, the first transitional side 3s and the second transitional side 3s can extend between a first end of the body and a second end of the body 3c. A projection 3p can extend from the second end of the body 3c of the cutting insert 3.

The first end mouth 4a of the first cutting side 3b can be curved, the second end mouth 4b of the first cutting side 3b can be curved, the first end mouth 4a of the second cutting side 3b can be curved, and the second end mouth 4b of the second cutting side 3b can be curved. The groove 4 of the first cutting side 3b can have a length L that extends from the first end mouth 4a of the first cutting side 3b to the second end mouth 4b of the first cutting side 3b. The first end mouth 4a of the first cutting side 3b can be offset relative to the second end mouth 4b of the first cutting side 3b such that a first centerline 8a passing linearly through a center of the first end mouth 4a of the first cutting side 3a toward the second end mouth 4b of the first cutting side 3b at an angle that is parallel to the axis of rotation AX of the cutting insert 3 is offset by an offset distance E1 from a second centerline 8b passing linearly through a center of the second end mouth 4b of the first cutting side 3b toward the first end mouth 4a of the first cutting side 3b at an angle that is parallel to the axis of rotation AX. The first and second centerlines 8a, 8b can be parallel to each other as well.

The groove 4 of the second cutting side 3b can have a length L that extends from the first end mouth 4a of the second cutting side 3b to the second end mouth 4b of the second cutting side 3b. The first end mouth 4a of the second cutting side 3b can be offset relative to the second end mouth 4b of the second cutting side 3b such that a first centerline 8a passing linearly through a center of the first end mouth 4a of the second cutting side 3b toward the second end mouth 4b of the second cutting side 3b at an angle that is parallel to the axis of rotation AX about which the cutting insert is rotatable is offset by an offset distance E1 of the second cutting side 3b from a second centerline 8b passing linearly through a center of the second end mouth 4b of the second cutting side 3b toward the first end mouth 4a of the second cutting side 3b at an angle that is parallel to the axis of rotation AX. The first and second centerlines 8a, 8b can be parallel to each other as well.

In some such embodiments or other embodiments, the first end mouth 4a of the second cutting side 3b can be offset relative to the second end mouth 4b of the second cutting side 3b such that a first centerline 8a passing linearly through a center of the first end mouth 4a of the second cutting side 3b toward the second end mouth 4b of the second cutting side 3b at an angle that is parallel to an angle at which the groove 4 of the second cutting side 3b extends along the length L of the groove 4 of the second cutting side 3b. Also, the first end mouth 4a of the first cutting side 3b can be offset relative to the second end mouth 4b of the first cutting side 3b such that a first centerline 8a passing linearly through a center of the first end mouth 4a of the first cutting side 3a toward the second end mouth 4b of the first cutting side 3b at an angle that is parallel to an angle at which the groove 4 of the first cutting side 3b extends along the length L of the groove 4 of the first cutting side 3 is offset by an offset distance E1 from a second centerline 8b passing linearly through a center of the second end mouth 4b of the first cutting side 3b toward the first end mouth 4a of the first cutting side 3b at an angle that is parallel to the angle at which the groove 4 of the first cutting side 3b extends along the length L of the groove 4 of the first cutting side 3b.

The offset distance E1 of the first cutting side can be between 0.1 mm and 1 mm offset distance E1 of the second cutting side is between 0.1 mm and 5 mm for some embodiments. In other embodiments, the offset distance can be other suitable distances.

In some embodiments, the first cutting side 3b can have a second wall 3e between the groove 4 of the first cutting side 3b and the flute 3f of the first cutting side 3b and the second cutting side 3b can also have a second wall 3e between the groove 4 of the second cutting side 3b and the flute 3f of the second cutting side 3b. For instance, the groove 4 of the first cutting side 3b can be positioned between the first wall 3g of the first cutting side 3b and the second wall 3e of the first cutting side 3b such that the groove 4 of the first cutting side 3b has a first wall edge that extends linearly from a first end 4e of the first end mouth 4a of the first cutting side 3b to a first end 4h of the second end mouth 4b of the first cutting side 3b along a pre-selected angle. The first wall edge of the first cutting side 3b can be positioned between the first wall 3g of the first cutting side 3g and the groove 4 of the first cutting side 3b. The groove 4 of the first cutting side 3b can also have a second wall edge that extends linearly from a second end 4g of the first end mouth 4a of the first cutting side 3b to a second end 4i of the second end mouth 4b of the first cutting side 3b along the pre-selected angle. The second wall edge of the first cutting side 3b can be positioned between the second wall 3e of the first cutting side 3b and the groove 4 of the first cutting side 3b. The pre-selected angle at which the first wall edge of the first cutting side 3b extends linearly can be between 0° and 60° and the pre-selected angle at which the second wall edge of the first cutting side extends linearly can be between 0° and 60°.

In some such embodiments, the groove 4 of the first cutting side 3b and the groove 4 of the second cutting side can each be defined to have a first wall edge adjacent the first wall 3g of their respective cutting sides such that a portion of the first wall 3g extends over a first portion of the groove 4 closest to the first wall 3g to enclose the first portion of the groove 4. The first portion of the groove 4 for each of the first and second cutting sides 3b can be in fluid communication with a central portion of the groove 4, which can be in direct fluid communication with the gap 4k.

In some embodiments, a portion of the cutting insert 3 positioned between the back shoulder edge (3d) and the gap 4k that is in communication with the groove 4 can be positioned to define a side of the groove 4 such that a portion of the groove 4 is within an overhang portion 4d of the first wall 3g that extends from a back shoulder edge and overhangs the portion of the groove 4. The larger sized second end mouth 4b of the groove 4 can be sized and shaped to help reduce stress experienced by the cutting insert 3 during cutting operations (e.g. rotation for undercutting, etc.). We have surprisingly found that a generally elliptical or oval shaped second end mouth 4b that has its center offset relative to a center of the first end mouth 4a of the groove 4 can facilitate a stress reduction while also providing an effective pathway for material to pass away from a workpiece and tool during operation.

In some embodiments, the cutting tool 1 can be provided so that the member 5 is rotated while the cutting insert 3 is retained in the moveable member 5 and the moveable member 5 is in the closed position. A work piece can be positioned adjacent the cutting insert 3 so that cutting edges 3t of the body 3c of the cutting insert 3 can engage the workpiece and cut into the workpiece to form a shaped aperture. The cutting can be an undercutting of the workpiece in some embodiments.

When the cutting edge(s) 3t contact the workpiece, material can be cut away from the workpiece. The material can be directed away from the cutting insert via flute 3f as the moveable member 5 is moved (e.g. rotated). The size and shape of the groove 4 adjacent the back shoulder edge 3d can permit a larger portion of the body 3c of the cutting insert 3 to be provided adjacent the back shoulder edge 3d while also reducing stress by providing a larger sized opening at the second end mouth 4b to facilitate improved cutting operation and reduced wear experienced by the cutting insert. This can help avoid portions of the body 3c of the cutting insert 3 from fracturing due to high stress during cutting operations to help improve the life of the cutting insert 3.

We have surprisingly found that the generally conical shaped groove 4 having a smaller first end mouth 4a and larger second end mouth 4b can be particularly helpful at reducing stress and wear experienced by the cutting tool This improvement can be further enhanced by defining the groove 4 so that a center of the first end mouth 4a is offset relative to a center of the second end mouth 4b as discussed above. For example, the centers of the first and second end mouths 4a, 4b can be offset such that a centerline 8a passing linearly through the center of the first end mouth 4a toward the second mouth 4b at an angle that is parallel to the axis of rotation AX and/or the angle at which the groove extends along its length L is offset by a preselected offset distance E1 from a centerline 8b passing linearly through the center of the second end mouth 4b toward the first end mouth 4a at an angle that is parallel to the axis of rotation AX and/or the angle at which the groove extends along its length L.

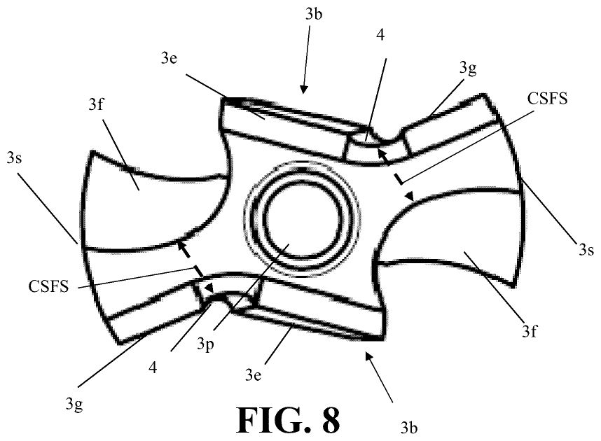

We have also found that when an elliptical shape for the first end mouth 4a and second end mouth 4b are utilized, a maximized radius of curvature for the groove 4 and a maximized cross section from the groove 4 on one cutting side 3b to the flute surface 3f on the opposite cutting side 3b (cross sections from the flute surface 3f on one cutting side 3b to groove 4 on the opposite cutting side 3b of the body 3c of the cutting insert 3 is indicated via arrows CSFS in FIG. 8).

The cross sectional distance between the groove 4 on one cutting side 3b to the flute surface 3f on the opposite cutting side 3b as indicated by arrows CSFS in FIG. 8 can be considered a thickness of the body 3c that linearly extends from the groove 4 and opposite flute 3f. For example, there can be a linearly extending distance between the groove 4 on the first cutting side 3b to the flute 3f on the second cutting side 3b that defines such a thickness of the body 3c that provides this cross sectional distance as indicated by arrow CSFS. This same feature can also be provided so that a cross sectional distance between the groove 4 on the second cutting side 3b to the flute surface 3f on the opposite first cutting side 3b as indicated by arrows CSFS in FIG. 8 can also be considered a thickness of the body 3c that linearly extends from the groove 4 on the second cutting side 3b to the flute 3f on the first cutting side 3b.

We have surprisingly found that this combination of features can help provide a significant reduction in stresses during operation. We have also surprisingly found that the shape and configuration of the groove 4 can be configured to preserve the areas of the first wall 3g and second wall 3e on the opposite cutting sides 3b, which can provide less wear (e.g. lower contact pressure) and, consequently, a longer life for the cutting insert 3.

It should be appreciated that the exemplary embodiments discussed herein can be adjusted to account for a particular set of design criteria. For example, the size and shape of the body of cutting insert 3, the size and shape of flutes 3f, generally conical shaped grooves 4, and the type of materials utilized for the cutting insert 3 can be any of a number of different options. For instance, the type of material used for the body of the cutting insert 3 can be carbide, cemented carbine, tungsten carbide, ceramic material, steel, tool steel, etc.). As another example, some embodiments can include one or more cutting elements attached to a cutting edge 3t of the cutting insert (e.g. a carbide material cutting element, a polycrystalline Diamond (PCD) cutting element, tungsten carbide element, a ceramic cutting element, a polycrystalline cubic boron nitride cutting element, a cubic boron nitride (CBN) cutting element, etc.) can be any of a number of suitable material (e.g. cubic boron nitride, ceramic material, other type of hard material, etc.). As yet another example, the moveable member 5 can be a rotatable shaft, rod, bar, or rail for a drill or cutting tool or may be another type of moveable elongated member. Thus, while certain present preferred embodiments of the cutting apparatus, cutting insert, and embodiments of methods for making and using the same have been shown and described above, it is to be distinctly understood that the invention is not limited thereto but may be otherwise variously embodied and practiced within the scope of the following claims.

What is claimed is:

1. A cutting apparatus comprising:
a cutting insert having a body, the body having at least one cutting side, each of the at least one cutting side configured to define a back shoulder edge and a first wall positioned between a groove and the back shoulder edge, the groove defined to be in communication with a first end mouth and a second end mouth opposite the first end mouth, the first end mouth being smaller than the second end mouth; a gap being defined in communication with the groove, the gap being tapered such that a portion of the gap adjacent the second end mouth is larger than a portion of the gap defined adjacent to the first end mouth.

2. The cutting apparatus of claim 1, wherein the first end mouth is curved, and the second end mouth is curved.

3. The cutting apparatus of claim 1, wherein the groove has a length that extends from the first end mouth to the second end mouth, the first end mouth being offset relative to the second end mouth such that a first centerline passing linearly through a center of the first end mouth toward the second end mouth at an angle that is parallel to an axis of rotation about which the cutting insert is rotatable, the first centerline passing linearly through a center of the first end mouth toward the second end mouth being offset by an offset distance from a second centerline passing linearly through a center of the second end mouth toward the first end mouth at an angle that is parallel to the axis of rotation about which the cutting insert is rotatable.

4. The cutting apparatus of claim 3, wherein the offset distance is between 0.1 mm and 1 mm.

5. The cutting apparatus of claim 2, wherein the groove is generally conical in shape.

6. The cutting apparatus of claim 5, wherein the groove is sized to be between half of a cone in shape to a quarter of a cone in shape.

7. The cutting apparatus of claim 6, wherein the groove is sized to be a third of a cone in shape.

8. The cutting apparatus of claim 1, wherein each of the at least one cutting side is configured to define a flute and a second wall positioned between the flute and the groove.

9. The cutting apparatus of claim 8, wherein the groove is positioned between the first wall and the second wall, the groove having a first wall edge that extends linearly from a first end of the first end mouth to a first end of the second end mouth along a pre-selected angle, the first wall edge being positioned between the first wall and the groove; and
the groove also having a second wall edge that extends linearly from a second end of the first end mouth to a second end of the second end mouth along the pre-selected angle, the second wall edge being positioned between the second wall and the groove.

10. The cutting apparatus of claim 9, wherein the pre-selected angle at which the first wall edge extends linearly is between 0° and 60° and the pre-selected angle at which the second wall edge extends linearly is between 0° and 60°.

11. The cutting apparatus of claim 9, wherein the first wall edge is defined such that a portion of the first wall extends over a first portion of the groove closest to the first wall to enclose the first portion of the groove, the first portion of the groove being in fluid communication with a central portion of the groove, the central portion of the groove being in direct fluid communication with the gap.

12. The cutting apparatus of claim 1, wherein the groove is defined to have a first wall edge adjacent the first wall such that a portion of the first wall extends over a first portion of the groove closest to the first wall to enclose the first portion of the groove, the first portion of the groove being in fluid communication with a central portion of the groove, the central portion of the groove being in direct fluid communication with the gap.

13. The cutting apparatus of claim 1 wherein the first wall extends linearly from the back shoulder edge to the gap.

14. The cutting apparatus of claim 1, wherein the at least one cutting side is configured to define a flute and a second wall positioned between the flute and the groove, the second wall extending upwardly away from the groove and the flute being curved as the flute extends from the second wall to a transition side of the body of the cutting insert.

15. The cutting apparatus of claim 1, comprising:
a projection extending from an end of the body of the cutting insert, the projection sized and configured to be received within a hole of a moveable member.

16. The cutting apparatus of claim 15, comprising:
the moveable member, the moveable member having a first portion that is moveable relative to a second portion such that the moveable member is adjustable between an open position and a closed position, the moveable member having the hole and the projection being insertable into the hole, the moveable member being rotatable.

17. The cutting apparatus of claim 16, wherein the at least one cutting side is configured for undercutting of a workpiece.

18. A cutting insert for a cutting apparatus comprising:
a cutting insert having a body, the body having a first cutting side, a second cutting side opposite the first cutting side, a first transitional side extending from a flute of the second cutting side to a back shoulder edge of the first cutting side, and a second transitional side extending from a flute of the first cutting side to a back shoulder edge of the second cutting side;
the first cutting side configured to define a first wall between the back shoulder edge of the first cutting side and a groove, the groove of the first cutting side defined to be in communication with a first end mouth and a second end mouth opposite the first end mouth, the first end mouth being smaller than the second end mouth; a gap of the first cutting side being defined in communication with the groove of the first cutting side, the gap of the first cutting side being tapered such that a portion of the gap adjacent the second end mouth is larger than a portion of the gap defined adjacent to the first end mouth,
the second cutting side configured to define a first wall between the back shoulder edge of the second cutting side and a groove of the second cutting side, the groove of the second cutting side defined to be in communication with a first end mouth and a second end mouth opposite the first end mouth of the second cutting side, the first end mouth of the second cutting side being smaller than the second end mouth of the second cutting side; a gap of the second cutting side being defined in communication with the groove of the second cutting side, the gap of the second cutting side being tapered such that a portion of the gap of the second cutting side adjacent the second end mouth of the second cutting side is larger than a portion of the gap of the second cutting side defined adjacent to the first end mouth of the second cutting side,
the first cutting side, the second cutting side, the first transitional side and the second transitional side extending between a first end of the body and a second end of the body.

19. The cutting insert for a cutting apparatus of claim 18, wherein:
wherein the first end mouth of the first cutting side is curved, the second end mouth of the first cutting side is curved, the first end mouth of the second cutting side is curved, and the second end mouth of the second cutting side is curved; and
wherein the groove of the first cutting side has a length that extends from the first end mouth of the first cutting side to the second end mouth of the first cutting side, the first end mouth of the first cutting side being offset relative to the second end mouth of the first cutting side such that a first centerline passing linearly through a center of the first end mouth of the first cutting side toward the second end mouth of the first cutting side at an angle that is parallel to an axis of rotation about which the cutting insert is rotatable is offset by an offset distance from a second centerline passing linearly through a center of the second end mouth of the first cutting side toward the first end mouth of the first cutting side at an angle that is parallel to the axis of rotation; and
wherein the groove of the second cutting side has a length that extends from the first end mouth of the second cutting side to the second end mouth of the second cutting side, the first end mouth of the second cutting side being offset relative to the second end mouth of the second cutting side such that a first centerline passing linearly through a center of the first end mouth of the second cutting side toward the second end mouth of the second cutting side at an angle that is parallel to the axis of rotation is offset by an offset distance of the second cutting side from a second centerline passing linearly through a center of the second end mouth of the second cutting side toward the first end mouth of the second cutting side at an angle that is parallel to the axis of rotation; and
wherein the offset distance of the first cutting side is between 0.1 mm and 1 mm and the offset distance of the second cutting side is between 0.1 mm and 1 mm.

20. The cutting insert for a cutting apparatus of claim 19, wherein the first cutting side has a second wall between the groove of the first cutting side and the flute of the first cutting side and the second cutting side has a second wall extending between the groove of the second cutting side and the flute of the second cutting side; and
wherein the groove of the first cutting side is positioned between the first wall of the first cutting side and the second wall of the first cutting side such that the groove of the first cutting side has a first wall edge that extends linearly from a first end of the first end mouth of the first cutting side to a first end of the second end mouth of the first cutting side along a pre-selected angle, the first wall edge of the first cutting side being positioned between the first wall of the first cutting side and the groove of the first cutting side, and
the groove of the first cutting side also has a second wall edge that extends linearly from a second end of the first end mouth of the first cutting side to a second end of the second end mouth of the first cutting side along the pre-selected angle, the second wall edge of the first cutting side being positioned between the second wall of the first cutting side and the groove of the first cutting side,
wherein the pre-selected angle at which the first wall edge of the first cutting side extends linearly is between 0° and 60° and the pre-selected angle at which the second wall edge of the first cutting side extends linearly is between 0° and 60°; and
wherein the groove of the second cutting side is positioned between the first wall of the second cutting side and the second wall of the second cutting side such that the groove of the second cutting side has a first wall edge that extends linearly from a first end of the first end mouth of the second cutting side to a first end of the second end mouth of the second cutting side along a pre-selected angle, the first wall edge of the second cutting side being positioned between the first wall of the second cutting side and the groove of the second cutting side, and
the groove of the second cutting side also has a second wall edge that extends linearly from a second end of the first end mouth of the second cutting side to a second end of the second end mouth of the second cutting side along the pre-selected angle, the second wall edge of the second cutting side being positioned between the second wall of the second cutting side and the groove of the second cutting side, and
the pre-selected angle at which the first wall edge of the second cutting side extends linearly is between 0° and 60° and the pre-selected angle at which the second wall edge of the second cutting side extends linearly is between 0° and 60°.
